(19) United States
(12) Patent Application Publication
(10) Pub. No.: US 2011/0218811 A1
(43) Pub. Date: Sep. 8, 2011

(54) RETAINING DEVICE FOR SINGING BALLOON AND BALLOON SINGING INCORPORATING SAME

(75) Inventors: An-Kuo Li, Zhubei City (TW); Jung-Ya Hsieh, Zhubei City (TW)

(73) Assignee: MEDICI CREATIVITY CO., LTD., Zhubei City (TW)

(21) Appl. No.: 13/039,299

(22) Filed: Mar. 2, 2011

(30) Foreign Application Priority Data
Mar. 2, 2010 (TW) 99106012
May 12, 2010 (TW) 99208824

(51) Int. Cl. G10L 21/00

(52) U.S. Cl. 704/272; 704/E21.001

(57) ABSTRACT

A singing balloon includes a balloon body, a balloon retaining body, an oscillator unit, an audio and power unit. When the balloon body is placed within an accommodating space defined by the balloon retaining body and the balloon body is allowed to be completely adhered to the oscillator unit, the music stored in the audio and power unit will be played. The balloon retaining body is formed with an abutting portion to ensure that the surface of the balloon body is completely adhered to the oscillator portion for playing music stably.

### CROSS-REFERENCE TO RELATED APPLICATIONS

This application claims foreign priority under 35 U.S.C. §119 to Taiwanese application numbers 99106012, filed Mar. 2, 2010, and 99208824, filed May 12, 2010, the contents of both of which are incorporated herein by reference in their entities.

### FIELD OF THE INVENTION

The present invention relates to a singing balloon. Specifically, the invention relates to a singing balloon that plays music by oscillation.

### DESCRIPTION OF THE PRIOR ART

Giving away balloons are very useful to liven up a festival atmosphere or promote products in many playgrounds or product marketing activities. To create joyful ambiance or succeed a best campaign of publicity for products, many balloon makers design a variety of cute and interesting balloon appearances, or bend and twist balloons to particular shapes; afterwards, new products go marketing one after another to make a diverse assortment of balloons.

As shown in FIG. 1, it is better for a kid's grip and prevents people from being bothered by floating balloons, many balloon makers fix the balloon body 1 in a prior balloon retaining bracket 2, wherein the balloon retaining bracket 2 is formed at the bottom thereof with a supporting holder 20 grafted on a supportive rod 21 for gripping the balloon body 1. The prior balloon retaining bracket 2 has a recess for holding a balloon's filing mouth 22 to blow up the balloon body 1, and then knot the balloon's filing mouth. Finally, getting the part nearest to the balloon's filling mouth wedged in the recess holder of balloon's filling mouth performs the job to fix the balloon body.

Due to the designing limitation of visual effect, it can only make changes to shapes, colors or patterns of the prior balloon body and its retaining bracket; therefore, it quite restricts the creativity or reduces the entertainment to make weak human sensory stimulation. Usually, gas leaking makes the balloon body gradually slack until completely shrunk, and it will be discarded together with the retaining bracket and the supportive rod, which actually are still working well, to result in waste and environmental pollution.

Hence, if the balloon body can generate sound and stable contact between the balloon body and the oscillator unit is assured to allow performing steady sound effects matching up different venues and requirements, the balloon body would become of more practical and functional. Additionally, different types of sound sources can be selected to change the content of music; thus, the balloon body will have the originality and turn into a portable speaker as well. Furthermore, in spite of the balloon body shrinking due to aging of rubber, merely replacing the balloon body but using the same retaining bracket can reduce unnecessary waste for the environment-friendly demand. The balloon body is more eye-catching whenever people pass by, makes people feel like holding it in hand for a long time, increases sensory stimulation, or enhances the entertainment that can undoubtedly create a greater demand for consumption market.

### SUMMARY OF THE INVENTION

An object of the invention is to provide a singing balloon, in which an oscillator unit is attached to a surface of the balloon body to allow that the surface of the balloon body resonates to generate sounds by oscillating the oscillator unit.

An object of the invention is to produce a singing balloon which will go with various venues and activities, matching up with different sound effects.

An object of the invention is to provide a singing balloon having changeable content of music and acting as a sound producing device.

An object of the invention is to provide a singing balloon, manually power-generated, just like a music box.

Another object of the invention is to provide a balloon retaining device for ensuring the balloon body to sing steadily.

Another object of the invention is to provide a singing balloon that sings steadily.

According to the invention, the singing balloon disclosed herein comprises: a hollow balloon body defined by a thin membrane and a balloon retaining device. The balloon retaining device comprises: a balloon retaining body for holding the balloon body; an oscillator unit comprising an oscillator attached to the balloon body; and an audio and power unit electrically connected to the oscillator unit and adapted for providing powder to and driving the oscillator unit.

The balloon retaining device as disclosed herein is useful for holding a hollow balloon body of a singing balloon defined by a thin membrane. The balloon retaining device comprising: a balloon retaining body for holding the balloon body; an oscillator unit comprising an oscillator attached to the balloon body; and an audio and power unit electrically connected to the oscillator unit and adapted for providing powder to and driving the oscillator unit.

According to the singing balloon disclosed herein, a user may start blowing up the balloon body through the balloon's filling mouth, swelling the balloon and fixing it in the retaining body, and attach the oscillator of the oscillator unit to a surface of the balloon body. Driven by the audio and power unit, the oscillator unit will produce and transmit oscillation to the adhered surface of the balloon body, which turns into a diaphragm that can play music and let the balloon body oscillate to make sound. After the singing balloons have been set up in the venue, they can play music stored in memory device, and further transfer and update music through wired or wireless appliances; even so, they can be speakers for live broadcasting. With regard to necessary power supply for oscillation and sound generation, a micro-generator can be selected besides common small batteries that kids would like to grip such balloons and have them powered by pulling the micro-generator, performing like a special-shaped and floating music box. Consequently, the balloon body can generate sound and play various music or sound effects to match up different venues, which can not only be accessible to multiple activities and demands, but also provide enrich variety and higher flexibility for a fun and novelty of the balloon body. Moreover, the balloon retaining device disclosed herein abuts the balloon body against the oscillator portion using an abutting portion, and makes both balloon body and oscillator portion closely adhered to each other. By the suppressing strength of the abutting portion, waves of oscillation can be constantly transmitted without interference so as not to result in loose contact owing to the balloon body is blown away; meanwhile, the balloon body will maintain the invariable operation of amplification. All objects described above will be achieved.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 shows a conventional balloon retaining device;

FIG. 2 shows a diagram of a first embodiment of the invention, illustrating an arch of multiple singing balloons;

FIG. 3 shows an internal schematic diagram of the oscillator unit shown in FIG. 1 for creating sound effects by oscillation;

FIG. 4 shows a diagram of a second embodiment of the invention, illustrating a balloon body made of metal membrane, and a balloon retaining body integrated with an oscillator unit, and the oscillator unit being connected to a computer via a USB connector;

FIG. 5 shows an internal schematic diagram of the oscillator unit shown in FIG. 4, illustrating that a piezoelectric element is mounted inside the oscillator unit and powered by built-in batteries;

FIG. 6 shows a diagram of a third embodiment of a helium-filled balloon in which a manually powered micro-generator is installed;

FIG. 7 shows an internal schematic diagram of the micro-generator shown in FIG. 6;

FIG. 8 shows a diagram of a balloon retaining device According to the fourth embodiment of the invention;

FIG. 9 shows a diagram of the balloon body compressed by the oscillator portion and the abutting portion;

FIG. 10 shows a diagram of a fifth embodiment of the balloon retaining device having a holding structure provided with an abutting portion;

FIG. 11 shows a perspective schematic diagram of the embodiment shown in FIG. 10 linking up a balloon body; and

FIG. 12 shows a diagram of a sixth embodiment of the invention illustrating that the balloon retaining device is modified in shape for better visual effect.

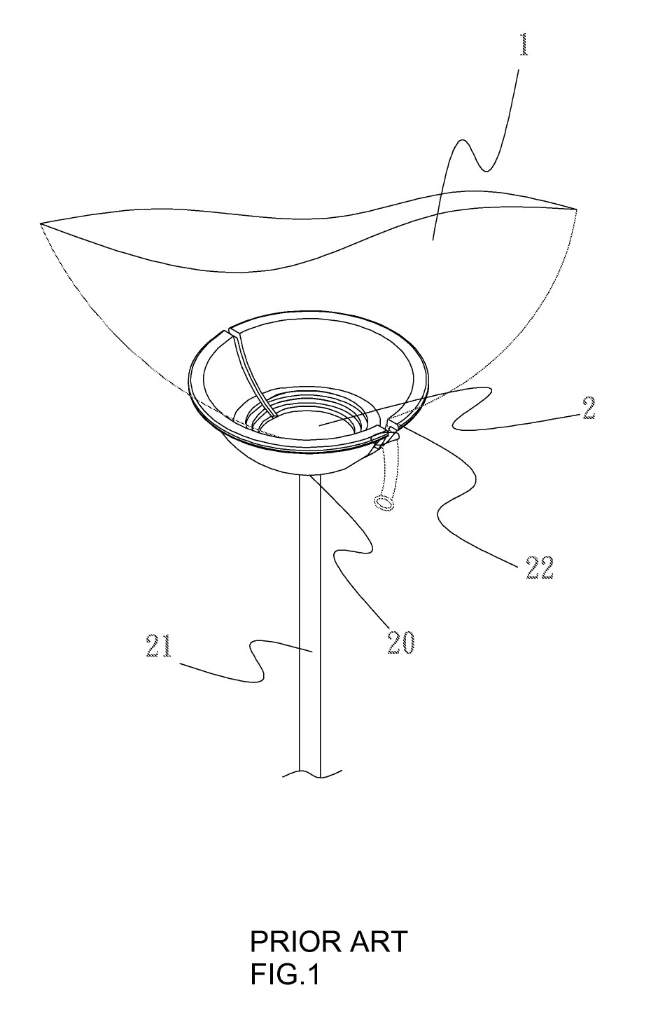

### DETAILED DESCRIPTION OF THE INVENTION

Regarding previous description of the invention and other techniques, features and performance, it will be described more fully hereinafter with reference to the accompanying drawings of preferred embodiments for clear presentation.

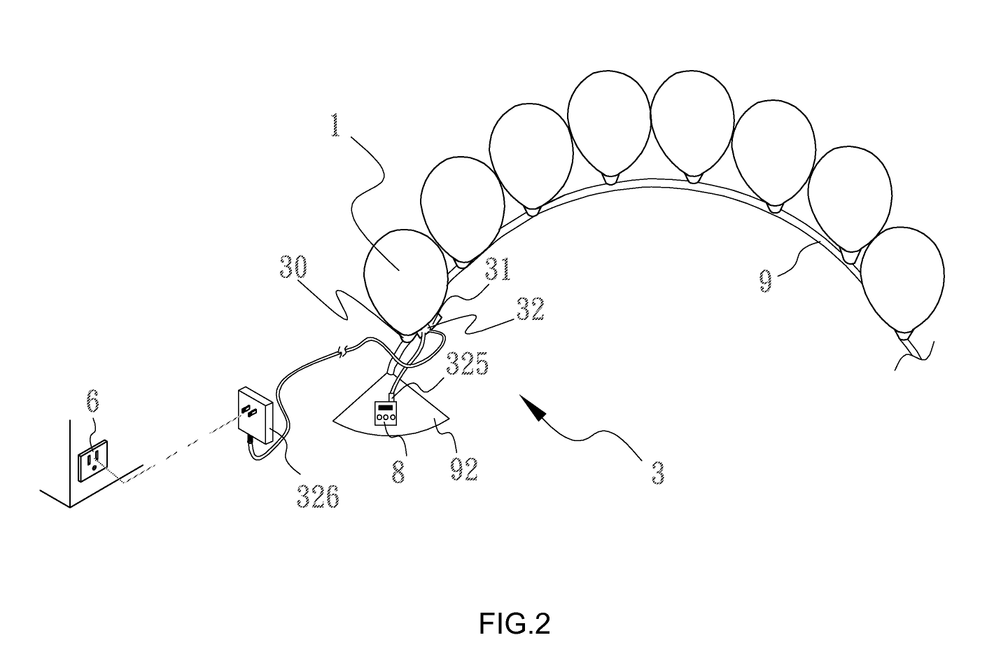

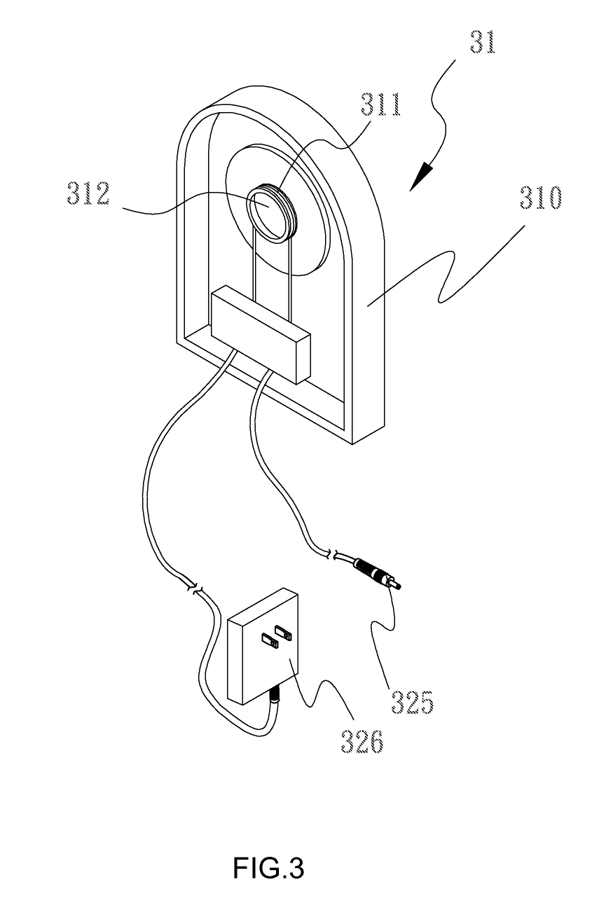

Please refer to FIGS. 2 and 3 both that show a balloon arch 9 comprising the singing balloons disclosed in the case. After filling up rubber balloon bodies 1, a user may separately tie up the filling mouths of them through a balloon retaining body 30; next, fix the balloon bodies 1 on the frame of the balloon arch 9 one after another. Now, one of the balloon bodies 1, such as one near a base 92, is chosen, and an oscillator unit 31 installed inside a housing and an audio and power unit 32 are attached to a surface of such a balloon body 1. For easier understanding of this example, the balloon retaining body 30, oscillator unit 31 and audio and power unit 32 are combined as a balloon retaining device 3. Among them, the audio and power unit 32 may by way of example comprise an audio terminal 325 and an external power plug 326. The audio terminal 325 is plugged to a MP3 player 8 near the balloon arch's base 92 to have sound source driving signals transmitted, and the power plug 326 is plugged to a power socket 6.

The oscillator unit 31 in this example comprises an oscillator coil 311 and a permanently magnetic oscillator 312 installed in the housing 310. Since the oscillator 312 is adhered to the surface of the balloon body 1, the oscillator unit 31 will be powered by the power socket 6 via the power plug 326, and receive sound signals from the audio and power unit 32 via the audio terminal 325; afterward, the sound signals will magnetize the oscillator coil 311 to bring about attraction/repelling interactions in the permanently magnetic oscillator 312 for oscillation, consequently the surface of the balloon body 1 attached with the oscillator unit 31 is oscillated in response to such sound signals, and generates sound.

Hence, the balloon arch 9 can be set up at the entrance as the start of red carpet in anniversary or wedding, and play suitable music or sound effects directly from the stored content of the MP3 player 8. If a user worries about the volume of the balloon body 1 wouldn't be enough, he/she can output sound signals from the same MP3 player 8 to multiple oscillator units 31 that can be separately adhered to different balloon bodies 1, simultaneously driving many balloons to perform synchronous sounding; that is, many balloons of the whole balloon arch 9 will play same music and attain to necessary volume and effect.

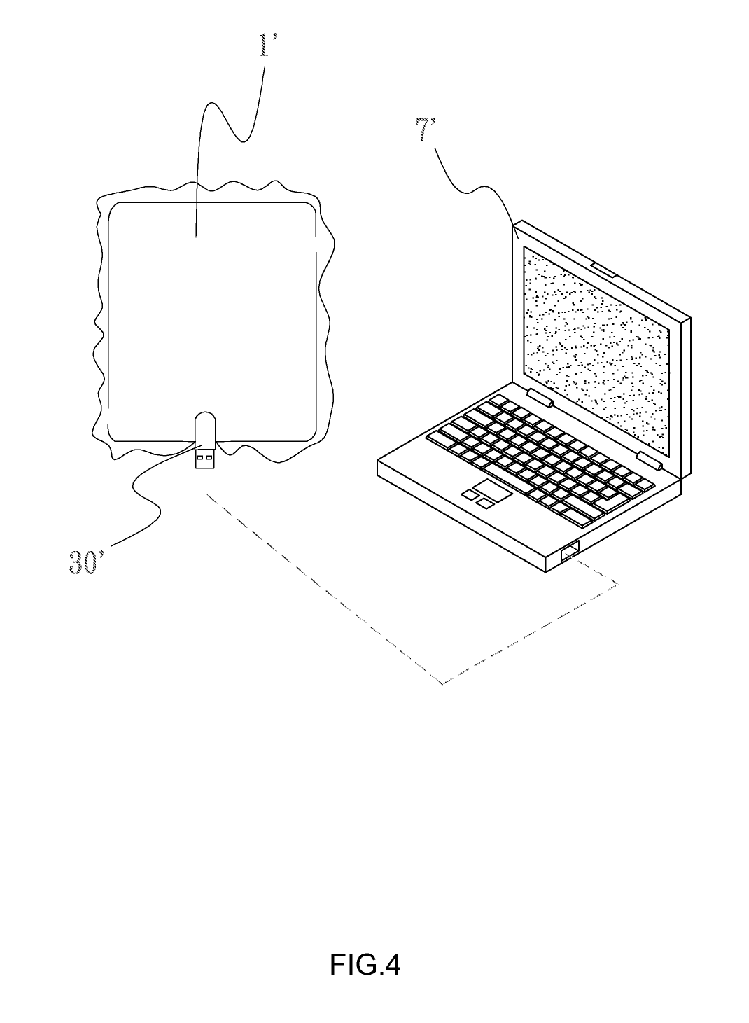

Certainly, those who have ordinary skills in this field of technology can easily understand that the above balloon body may not necessarily be made of flexible rubber only, which also can be metal membrane, and that the oscillator unit and the audio and power unit can have a variety of forms. As shown in FIG. 4 and FIG. 5, a second embodiment of the invention illustrates a metal-membrane balloon body 1′ as an example. For convenient assembly, an oscillator unit 31′ according to this embodiment has been integrated to a balloon retaining body 30′ so that the balloon body 1′ can be linked to the balloon retaining body 30′ after being filled with gas and the oscillator can be adhered to the balloon body 1′ at the same time. The oscillator according this embodiment is a piezoelectric element 313′ that can produce oscillation with changes in the crystal lattice size of the element 313′ due to voltage changes of the applied signals. Due to its extremely small size, the piezoelectric element 313′ makes the oscillator unit 31′ getting thinner, and one side of this element 313′ fixed on the housing 310′ of the oscillator unit 31′; and the other side adhered to and oscillate the balloon body 1′.

The audio and power unit 32′ according to this embodiment comprises a flat rechargeable battery 320′, a memory device 322′, a microprocessor 323′, an universal serial bus (USB) connector 324′ and a wireless signal receiver 327′. Users can access preset music data from a computer 7′ through a USB connector 324′, and then store them to the memory device 322′. While playing music, the microprocessor 323′ commands to get data, outputs sound signals to the oscillator unit 31′, driving the piezoelectric element 313′ to oscillate, and then the balloon body 1′ oscillates and generates sound, so that users can play their recorded favorite music to make the balloon body 1′ a speaker playing music.

Additionally, a wireless signal receiver 327′ receives specific signals as triggering signals to activate and drive the micro processor 323′ to operate. Hence, take the zoo as an example that balloons can be given away while visitors are boarding tour vehicle. Wireless transmitters are installed in attractions of zoo, and all balloons in the vehicle will together receive triggering wireless signals arriving at a specific spot, broadcasting preset guiding data. Visitors might even be allowed to bring such balloons into the Haunted Mansion, where balloons can make special sound effect upon visitor's arrival at a specific spot, and visitors seemingly experience real participation and presence. Of course, the above USB connector 324′ can be replaced with wireless transmission devices, such as a bluetooth device or an infrared transmission device.

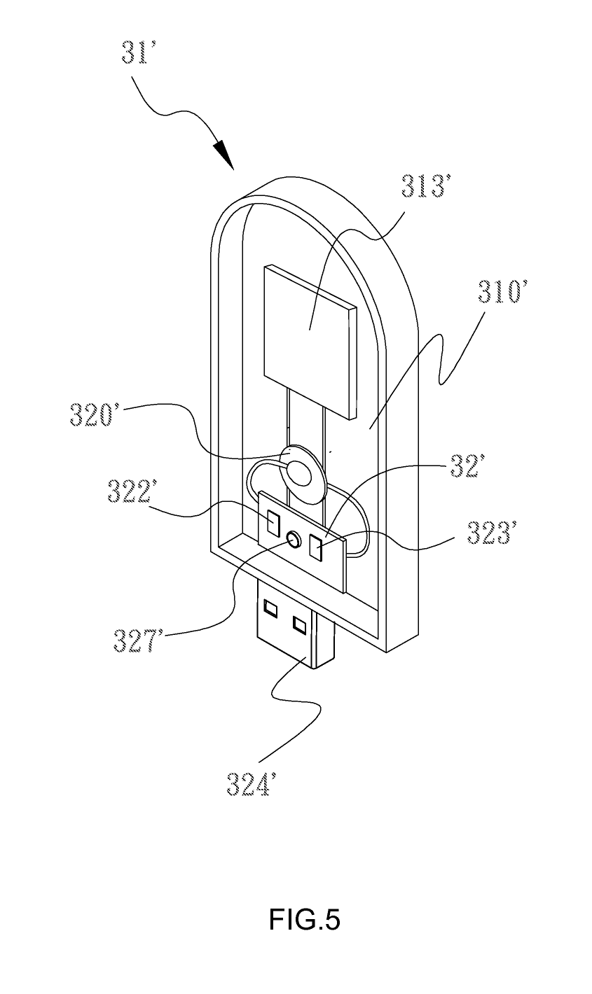

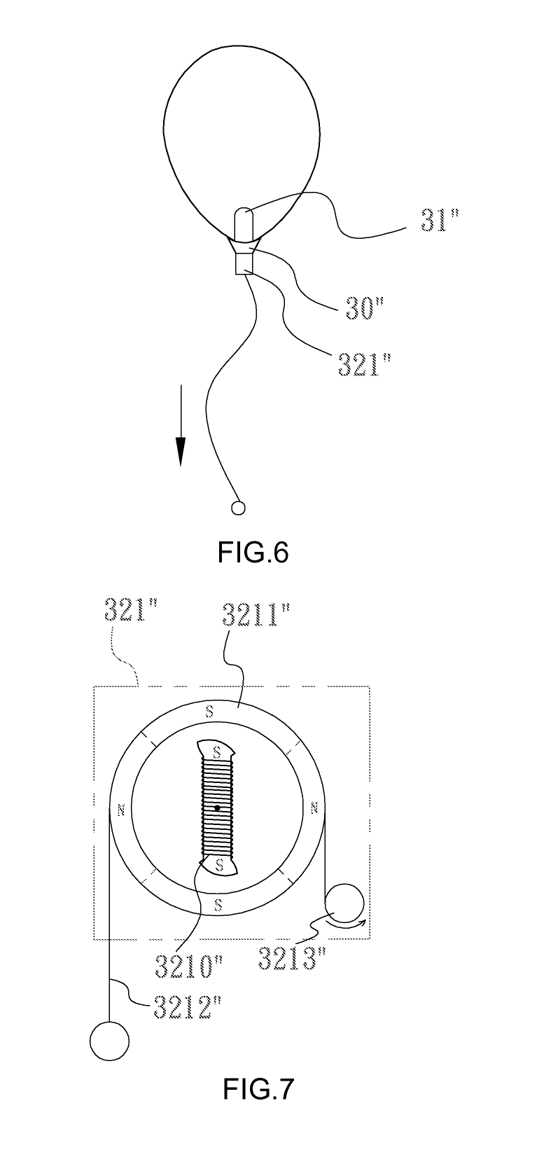

As shown in FIG. 6 and FIG. 7, a third embodiment of the invention presents a floating balloon body after being filled with helium, its audio and power unit powered by a micro-generator 321″, and the external housing of the balloon body and of oscillator unit 31″, and the balloon retaining body 30″ altogether integrated into one piece. The micro-generator 321″ of this example comprises a stator coil 3210″ stationed in a relative position to the balloon body 30″, a permanent-magnet rotor 3211″ for rotating around a pivotal axis in a relative position to the stator coil 3210″, a pull rope 3212″ for driving the permanent-magnet rotor 3211″ to rotate around the pivotal axis by moving from a retracted position to a protracted position, and an elastic element 3213″ for rolling up and restoring the pull rope 3212″.

Particularly to make a simple structure for the balloon, the pull rope 3212″ itself is a tether for the balloon. People gripping a balloon want to listen to music by holding the balloon retaining body 30″ in one hand, and the other hand pulling down the tether to drive the permanent-magnet rotor 3211″ to rotate. And then, the stator coil 3210″ produces electric energy to drive the oscillator unit 31″ to play music in compliance with oscillation signals. Following, the tether will be driven by an elastic element 3213″ to gradually return to the start and, during the process, the permanent-magnet rotor 3211″ will be driven again to rotate relative to the stator coil 3210″ and generate power. Therefore, the balloon's memory device can save hundreds of songs that kids gripping such balloons are able to pull the tether again and again, just like a traditional music box constantly singing different songs. Singing balloons will not only create happier atmosphere, but also accomplish greater and more powerful advertising effect than conventional ones.

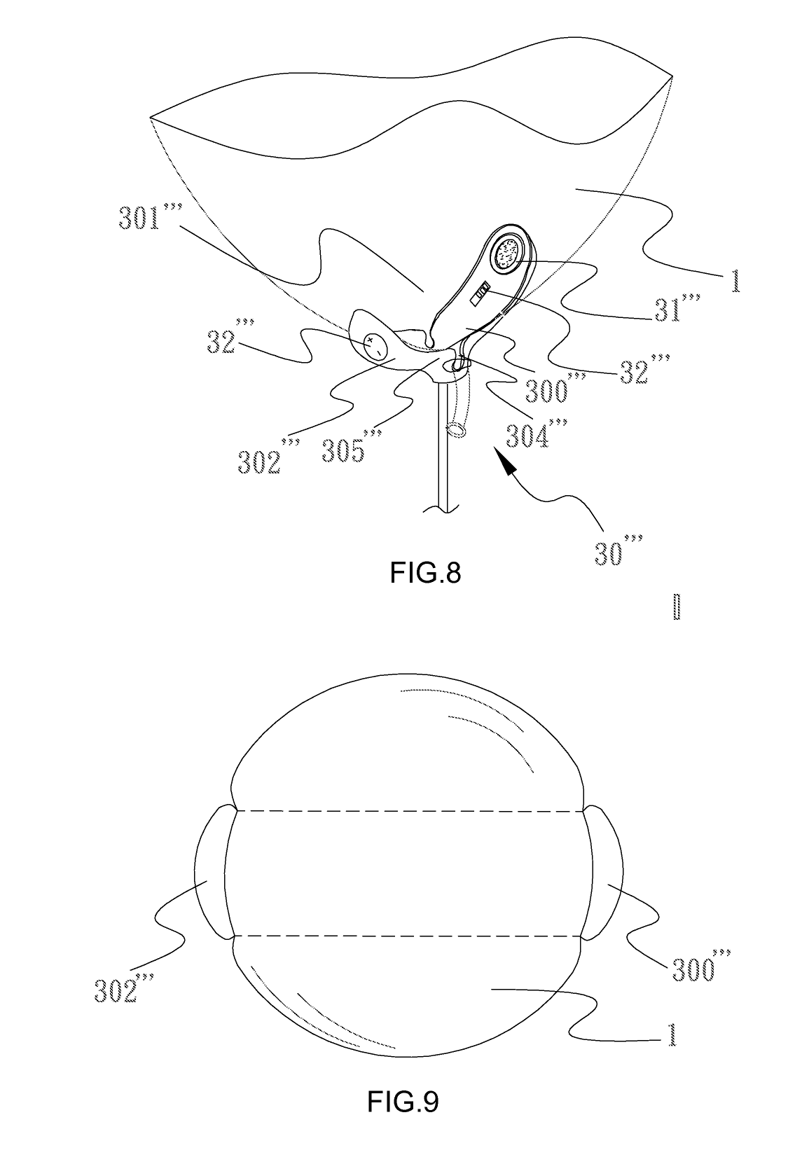

As shown in FIG. 8, it is a fourth embodiment of the invention that the balloon retaining body 30′″ is formed with an accommodating space 301′″ for part of a balloon body. A recess at the edge of the balloon retaining body 30′″ lets users willingly fix or remove the balloon body 1 on their own. A holder 304′″ of a singing balloon's filing mouth is to fix the balloon's filling mouth for tying the balloon tight. In this example, the audio source of the audio and power unit 32′″ is an integrated system-on-a-chip (SOC), including an electrically erasable programmable read only memory (EEPROM), a power module, a switching module, and a voice output module. The integrated circuits (IC) of this type feature on cheap price, low power consumption and compact size that users can place it inside the balloon retaining body 30′″ to fit the applications of read-only recording and less memory demand, such as playing campaign slogans, music in fast food restaurants, product promotion announcement, movie advertisement or toys' sound effects. The powering function of the audio and power unit 32′″ may by way of example be derived from a mercury battery which provides the audio source and the oscillator unit 31′″ with necessary power.

Please also refer to FIG. 9 using the above structure to have a filled and swollen balloon body 1 fixed in the joint accommodating space 301′″ between an oscillator portion 300′″ and an abutting portion 302′″. Since the distance between the oscillator portion 300′″ and the abutting portion 302′″ is a little shorter than the balloon body ldiameter, compression happens. In that situation, an elastically restoring portion 305′″ of the balloon retaining body provides an acting force due to change in elastic potential energy, applying toward the balloon on the contact between the elastically restoring portion 305′″ and the balloon. Besides, due to the relationship between the acting force and the counter-acting force, the balloon will impose a biasing force on the contact area of the oscillator portion 300′″ and the abutting portion 302′″ to make the surface of the balloon closely adhered to the oscillator portion 300′″.

Next, the oscillator unit 31′″, disposed on the side of the balloon retaining body 30′″ where the oscillator portion 300′″ and the abutting portion 302′″ are mounted, activates upon receiving power from the audio and power unit 32′″, and receives audio signals to provide the corresponding oscillation. By the performance of the oscillator portion 300′″ and the abutting portion 302′″ as described above, the oscillator unit 31′″ is forced to transmit such oscillation to the surface of the balloon body 1. The membrane surface of the balloon body 1 will be driven to generate synchronous oscillation and vibrate the air to play music. Furthermore, the balloon body 1 is adhered closely to the oscillator unit 31′″ after being pressed by the abutting portion 302′″ that the above singing balloon can play music, and provide excellent and steady sound as well.

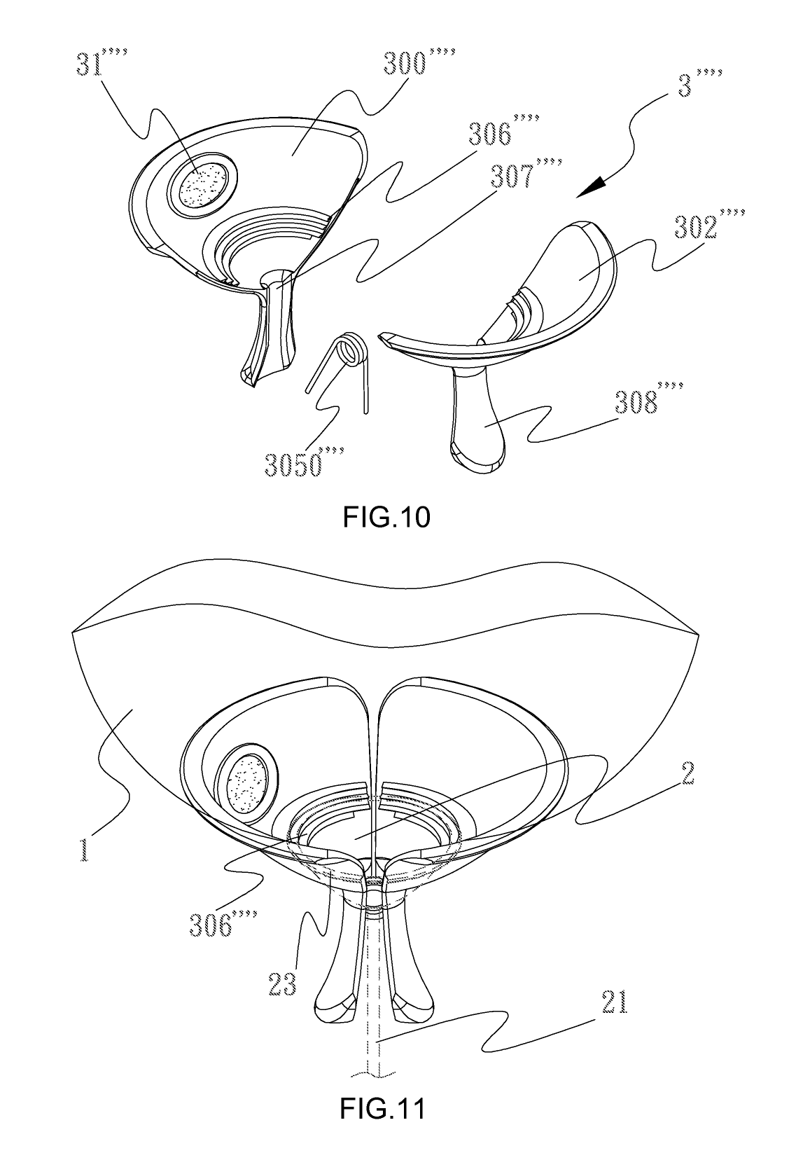

FIG. 10 and FIG. 11 show a fifth embodiment of the invention, in which the balloon retaining device 3″″ is configured in the form of a clip equipped with a metal spring 3050″″. As described above, this holder is composed of two plates, one plate of oscillator portion 300″″ with a built-in oscillator unit 31″″, and the other plate of abutting portion 302″″. Both plates are joined through the inner surfaces to form grooves 306″″ to fix a flange 23 extending from a conventional balloon retaining bracket 2. These two plates are linked by spring 3050″″, below which the oscillator portion 300″″ and abutting portion 302″″ form a press portion 308″″, respectively, as illustrated in FIGS. 10 and 11.

According to this embodiment, the balloon retaining device 3″″ is formed with a through hole 307″″ for receiving a supportive rod 21 of the conventional balloon retaining bracket 2. Therefore, when parents buy kids a conventional balloon body 1, they can have a supportive rod 21 piercing into the through hole 307″″ from top to bottom, and press the press portions 308″″ extending downward from the oscillator portion 300″″ and the abutting portion 302″″, so as to make the oscillator portion 300″″ and abutting portion 302″″ to move away from each other. After the balloon retaining body enters the space defined by the oscillator portion 300″″ and abutting portion 302″″, the user can use the circling grooves 306″″ holding the flange 23 extending from the conventional balloon retaining bracket 2. Thence, the holder's elastic restoring force imparted by the spring 3050″″ can greatly hold tight the flange 23 of the conventional balloon retaining bracket 2, and allow the flange 23 to be firmly inserted into the grooves 306″″.

Additionally, the funnel shape of the balloon retaining device 3″″ and the conventional balloon retaining bracket 2 can prevent the balloon from floating away, further making a better linking. Besides, the oscillator unit 31″″ is located above the grooves 306″″, firmly touching and adhering to the balloon body 1 by a holding force, so that the balloon body 1 can oscillate and play music or voice. Generally, the invention is suitable for the conventional balloon retaining bracket 2, easy installation and disassembly for playing music or voice if necessary.

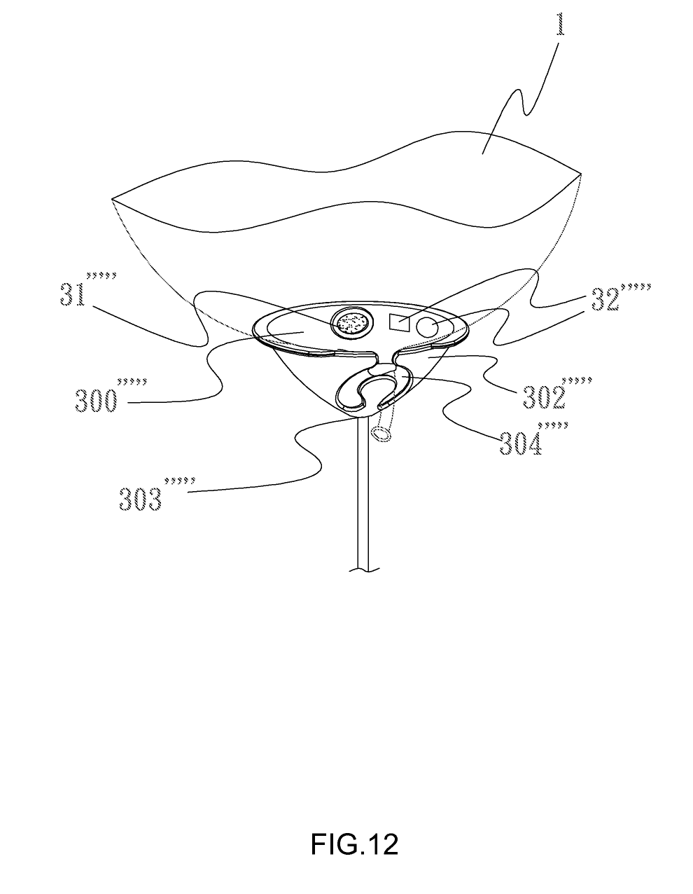

As shown in FIG. 12, a sixth embodiment of the invention tries to present more visual effects in the appearance of the balloon retaining device, so long as the oscillator portion 300′″″ and the abutting portion 302′″″ remain to force the balloon body 1 to be closely adhered to the oscillator unit 31′″″ and the balloon retaining device remains adapted for the audio and power unit 32′″″. The balloon retaining device according to this embodiment, as well as the outlines of the holder 303′″″ for receiving a supportive rod and the holder 304′″″ for receiving a balloon's filing mouth, may be designed to have different shapes according to balloon makers' demand and, and further achieve the purposes of publicity, promotion and entertainment.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A singing balloon comprising:
a hollow balloon body defined by a thin membrane; and
a balloon retaining device comprising:
a balloon retaining body for holding the balloon body, wherein the balloon retaining body further comprises an oscillator portion, and an abutting portion which defines, together with the oscillator portion, an accommodating space for accommodating the hollow balloon body and is adapted for pressing the accommodated balloon body into contact with the oscillator portion;
an oscillator unit comprising an oscillator attached to the balloon body, wherein the oscillator unit is mounted on the oscillator portion of the balloon retaining body at a side of the oscillator portion facing the accommodating space; and
an audio and power unit electrically connected to the oscillator unit and adapted for providing powder to and driving the oscillator unit.

2. The singing balloon according to claim 1, wherein the audio and power unit comprises a battery.

3. The singing balloon according to claim 1, wherein the audio and power unit comprises a micro-generator.

4. The singing balloon according to claim 3, wherein the micro-generator comprises:
a stator coil positioned relative to the balloon body;
a permanent-magnet rotor for rotating about a pivotal axis relative to the stator coil;
a pull rope for driving the permanent-magnet rotor to rotate about the pivotal axis by moving from a retracted position to a protracted position; and
an elastic element for retracting the pull rope from the protracted position back to the retracted position.

5. The singing balloon according to claim 1, wherein the audio and power unit comprises a memory device for storing audio data and a microprocessor for reading the audio data from the memory device and outputting the audio data to drive the oscillator unit to oscillate.

6. The singing balloon according to claim 5, wherein the audio and power unit further comprises a universal serial bus (USB) connector for receiving an audio data from an external source and transmitting the audio data to the memory device for storage.

7. The singing balloon according to claim 1, wherein the oscillator unit further comprises a piezoelectric element.

8. A balloon retaining device for holding a hollow balloon body of a singing balloon defined by a thin membrane, the balloon retaining device comprising:
a balloon retaining body for holding the balloon body, wherein the balloon retaining body comprises an oscillator portion, and an abutting portion which defines, together with the oscillator portion, an accommodating space for accommodating the balloon body and is adapted for pressing the accommodated balloon body into contact with the oscillator portion;
an oscillator unit comprising an oscillator attached to the balloon body, wherein the oscillator unit is mounted on the oscillator portion of the balloon retaining body at a side of the oscillator portion facing the accommodating space; and
an audio and power unit electrically connected to the oscillator unit and adapted for providing powder to and driving the oscillator unit.

9. The balloon retaining device according to claim 8, wherein the audio and power unit comprises a battery.

10. The balloon retaining device according to claim 8, wherein the audio and power unit comprises a micro-generator and the micro-generator comprises:
a stator coil positioned relative to the balloon body;
a permanent-magnet rotor for rotating about a pivotal axis relative to the stator coil;
a pull rope for driving the permanent-magnet rotor to rotate about the pivotal axis by moving from a retracted position to a protracted position; and
an elastic element for retracting the pull rope from the protracted position back to the retracted position.

11. The balloon retaining device according to claim 8, wherein the balloon retaining body further comprises a holder extending away from the accommodating space and adapted for holding a supportive rod.

12. The balloon retaining device according to claim 8, wherein the balloon retaining body is further formed with a recess for holding a filling mouth of the singing balloon.

13. The balloon retaining device according to claim 8, wherein the balloon retaining body further comprises an elastically restoring portion mounted between the oscillator portion and the press portion, the elastically restoring portion being configured in the form of a spring coupling between the oscillator portion and the press portion, and wherein the oscillator portion and the abutting portion are each extended with a press portion for bringing the oscillator portion and the abutting portion away from each other in response to being pressed.
